(19) United States
(12) Patent Application Publication
(10) Pub. No.: US 2011/0047341 A1
(43) Pub. Date: Feb. 24, 2011

(54) REMOTE DATA BACKUP METHOD AND REMOTE DATA BACKUP SYSTEM USING THE SAME

(75) Inventors: Seung-dong YU, Osan-si (KR); Woo-yong Chang, Yongin-si (KR); Se-jun Park, Yongin-si (KR); Min-jeong Moon, Seongnam-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/860,529

(22) Filed: Aug. 20, 2010

(30) Foreign Application Priority Data
Aug. 21, 2009 (KR) 10-2009-0077499

(51) Int. Cl. G06F 12/16

(52) U.S. Cl. 711/162; 711/E12.103

(57) ABSTRACT

A remote data backup method and a remote data backup system using the same are provided. The remote data backup system includes a data generating device which transmits data based on communication status, a data transmitting device which transmits the received data to outside, and a remote backup device which backs up the received data on real-time basis. As a result, images are transmitted to outside and backed up on real-time basis.

### CROSS-REFERENCE TO RELATED APPLICATIONS

This application claims priority from Korean Patent Application No. 10-2009-0077499, filed on Aug. 21, 2009, in the Korean Intellectual Property Office, the disclosure of which is incorporated herein by reference in its entirety.

### BACKGROUND OF THE INVENTION

1. Field of the Invention

Methods and systems consistent with the disclosure provided herein relate to a remote data backup method and a remote data backup system using the same, and more particularly, to a remote data backup method for backing up generated data on real-time basis and a remote data backup system using the same.

2. Description of the Related Art

More digital storage devices provide larger capacities with the better compression technology. The data storage capacity has grown rapidly, and accordingly, as the device's storage spaces are provided sufficiently, users are now able to store a variety of data in a variety of devices, respectively.

But one drawback with this is that, since various data is distributed and stored in a plurality of devices, data management can be inefficient. Accordingly, in order to solve the difficulty of data management, many users seek the answer in the large capacity storage devices such as a central server.

However, while the large capacity storage devices manage the data, users are still not free from the responsibility of having to back up the data to the central server if the data is generated by, or stored on their own devices, and this process can be quite cumbersome.

### SUMMARY OF THE INVENTION

Exemplary embodiments of the present inventive concept overcome the above disadvantages and other disadvantages not described above. Also, the present inventive concept is not required to overcome the disadvantages described above, and an exemplary embodiment of the present inventive concept may not overcome any of the problems described above.

According to one embodiment, a remote data backup method for backing up generated images on real-time basis and a remote data backup system using the same are provided.

In one embodiment, a remote data backup system may include a data generating device which generates image or voice data, and transmits the generated data to outside based on a communication status, a data transmitting device which transmits the received data to outside, if receiving from the data generating device the generated data, and a remote backup device which backs up the data received from the data generating device or the data transmitting device on real-time basis.

The data generating device may transmit the generated data to the data transmitting device or the remote backup device based on whether or not: the data generating device has a sufficient memory capacity; the data transmitting device is found near the data generating device; a command to transmit the data is received from the data transmitting device or the remote backup device; or the data generating device is set to an image transmission mode based on a user's manipulation.

The data generating device may transmit the generated data to the remote backup device, if communication with the remote backup device is possible, and transmit the generated data to the data transmitting device, if communication with the remote backup device is impossible.

The data generating device may select a device from a list of devices communicable with the data generating device, based on communicability with the remote backup device, and determine the selected device as the data transmitting device.

The device with the communicability with the remote backup device may be selected directly by a user, or in consideration of at least one of: communicational sensitivity with the data generating device; communicational sensitivity with the remote backup device; communication history records with the data generating device; error rate during communication with the data generating device; and whether or not the device is used by the user.

In another embodiment, a remote data backup method is provided. The remote data backup method may include generating image or voice data, and transmitting the generated data to outside along with information about a backup destination of the generated data, at a device receiving the data, determining the backup destination of the data, and at the device receiving the data, transmitting the data to the determined backup destination.

As a result, the generated data can be transmitted to outside for backup on real-time basis.

### BRIEF DESCRIPTION OF THE DRAWINGS

The above and/or other aspects of the present inventive concept will be more apparent by describing certain exemplary embodiments of the present inventive concept with reference to the accompanying drawings, in which:

FIG. 1 is a view illustrating a remote backup system according to an embodiment;

FIG. 2 is a detailed block diagram of a digital camera;

FIGS. 3A to 3D illustrate a screen for setting a mode according to an embodiment;

FIGS. 4A to 4D are views provided to explain a situation where a digital camera transmits data to a server via mobile phone;

FIG. 5 is a block diagram of a digital camera to transmit photographed images to the server on real-time basis;

FIG. 6 is a flowchart provided to explain a process of transmitting a photographed image on real-time basis;

FIG. 7 is a block diagram of a mobile phone;

FIG. 8 is a view provided to explain a method of transferring data through a plurality of data transfer devices;

FIG. 9 is a view provided to explain a method of transferring data through a plurality of data transfer devices; and

FIG. 10 is a view provided to explain a method of transferring data through a plurality of data transfer devices.

### DETAILED DESCRIPTION OF EXEMPLARY EMBODIMENTS

Certain exemplary embodiments of the present inventive concept will now be described in greater detail with reference to the accompanying drawings.

In the following description, same drawing reference numerals are used for the same elements even in different drawings. The matters defined in the description, such as detailed construction and elements, are provided to assist in a comprehensive understanding of the present inventive concept. Accordingly, it is apparent that the exemplary embodiments of the present inventive concept can be carried out without those specifically defined matters. Also, well-known functions or constructions are not described in detail since they would obscure the invention with unnecessary detail.

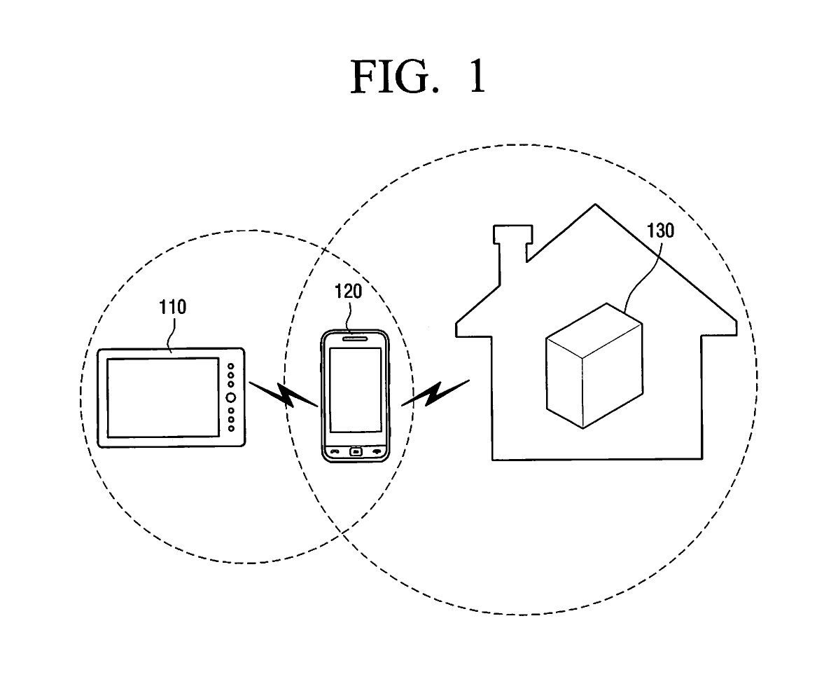

FIG. 1 is a view illustrating a remote backup system 100 according to an embodiment. The remote backup system 100 backs up the data generated at a specific device on a central server on real-time basis.

The remote backup system 100 may include a digital camera 110, a mobile phone 120, and a server 130.

The digital camera 110 may be implemented as a data generating device which directly generates image data by photographing an object. Accordingly, the digital camera 110 photographs an object, and transfers the generated corresponding image data to the server 130 via mobile phone 120 on real-time basis. Specifically, the digital camera 110 may transmit the generated image data to the mobile phone 120 in a short-range communication manner, and then the image data may be transferred to the server 130 from the mobile phone 120 in a telecommunication manner.

The mobile phone 120, which is a communication tool through which a user can communicate with an average phone subscriber or another mobile phone subscriber, may be implemented as a data transmission device which transmits image data received from an external device to the server 130. The mobile phone 120 may receive from the digital camera 110 the image data generated at the digital camera 110 in a short-range communication manner such as Bluetooth.

Additionally, the mobile phone 120 may transmit the received image data from the digital camera 110 to the server 130 in a telecommunication manner such as wireless Internet. In other words, the mobile phone 120 enables trans-networking of the image data, which is generated at the digital camera 110 and then transferred, to the server 130 in a communication manner other than that implemented in the data transmission of the digital camera 110.

The server 130 may be implemented as a remote distance backup device which receives image data from the mobile phone 120 in a telecommunication manner such as wireless Internet, and stores the received data therein. While the digital camera 110 and the mobile phone 120 have portability, the server 130 may be provided largely at homes.

Hereinbelow, a process of transmitting an image generated at the digital camera 110 to the mobile phone 120 will be explained in detail with reference to the structure of the digital camera 110.

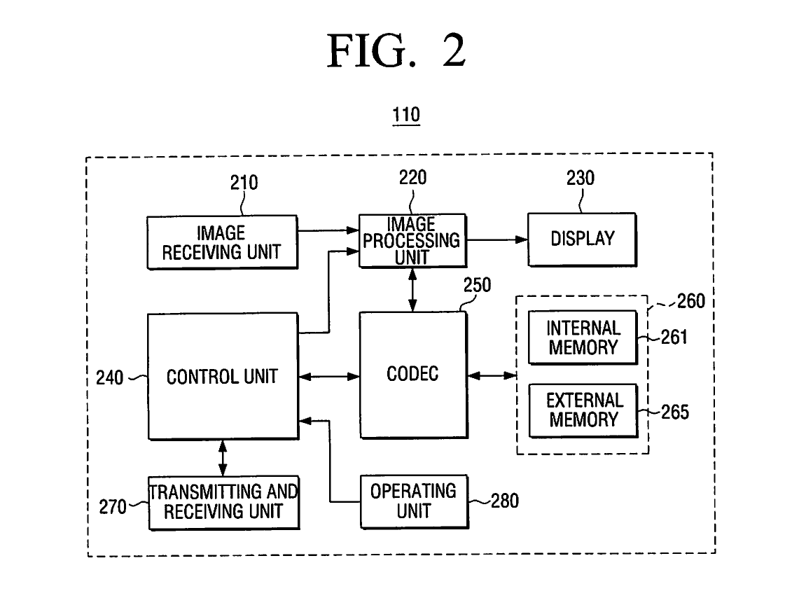

FIG. 2 is a detailed block diagram of the digital camera 110. Referring to FIG. 2, the digital camera 110 may include an image receiving unit 210, an image processing unit 220, a display 230, a control unit 240, a codec 250, a memory 260, a transmitting and receiving unit 270, and an operating unit 280.

The image receiving unit 210 may include pixels, and an AD converter which photoelectrically converts the light entering through a lens into an electric signal, and performs signal processing with respect to the electric signal. Each pixel outputs an image signal in an analog fashion, and the AD converter converts the analog image signal into an image signal in a digital fashion and outputs the resultant data.

The image processing unit 220 may perform signal processing with respect to the image inputted from the image receiving unit 210, and transmits the processed image signal to the display 230 to display the photographed image. Additionally, the image processing unit 220 outputs the signal-processed image signal to the codec 250 where the photographed image is stored.

The display 230 may display the image received from the image processing unit 220. Accordingly, the user may check the photographed image by looking at the image presented on the display 230.

The codec 250 may encode the image signal received from the image processing unit 220, and transmit the encoded image signal to the control unit 240 or the memory 260. The encoded image signal may be transmitted to the control unit 240 or the memory 260, depending on the mode of the digital camera 110.

That is, if the digital camera 110 is in an image transmission mode, the image encoded at the codec 250 is transmitted to the transmitting and receiving unit 270 via control unit 240. Accordingly, when the digital camera 110 is in the image transmission mode, the photographed image is not stored in the memory 260, but instead transmitted to the transmitting and receiving unit 270 via control unit 240 to be transmitted to outside on real-time basis.

If the digital camera 110 is in an image storage mode, the encoded image from the codec 250 is transmitted to the memory 260, and stored in either an internal memory 260 or an external memory 265 depending on the setting by the user.

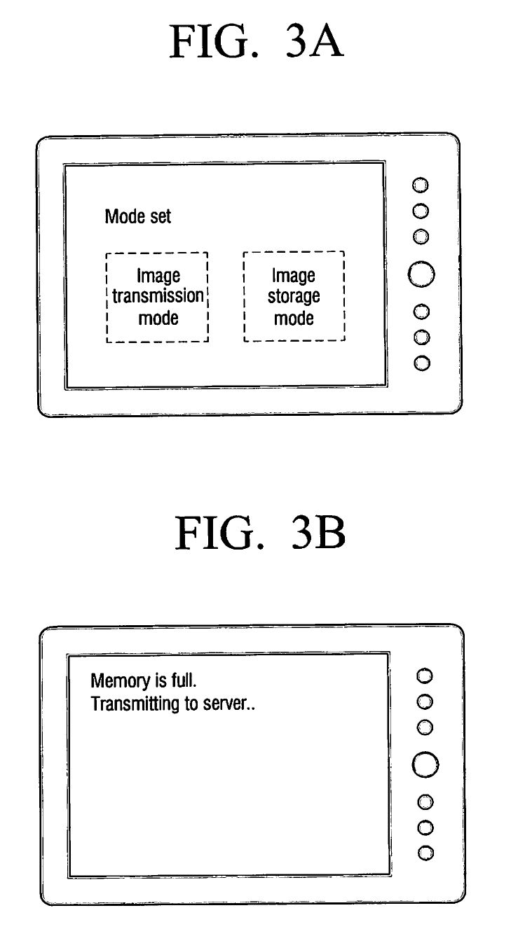

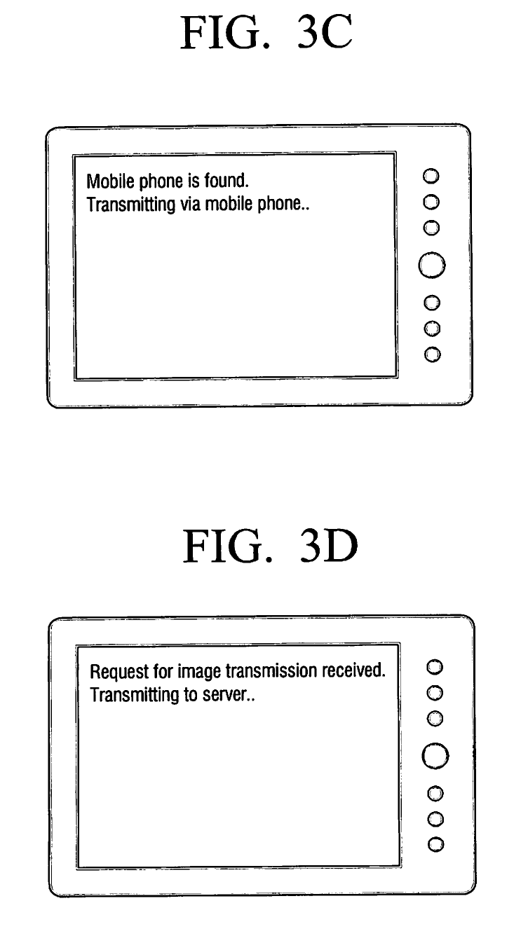

The user may manually set the mode of the digital camera 110, or under specific circumstances, the digital camera 110 may automatically operate in a corresponding mode. This will be explained in greater detail below, with reference to FIGS. 3A to 3D.

Meanwhile, the memory 260 may store the image encoded at the codec 250. The storage unit 160 may include the internal memory 261 such as a flash memory, a hard disk, or a DVD which is built in the digital camera 110, and an external memory 265 such as a SD card, or CF card which is removable from the digital camera 110.

The transmitting and receiving unit 270 may transmit the image data to the external devices, or receive a request message from the external devices for transmission of the image data. Specifically, if the digital camera 110 is in image transmission mode, the transmitting and receiving unit 270 may transmit the image, which is received at the image receiving unit 210 and encoded at the codec 250, to the external device such as the mobile phone 120 or the server 130, or receives a request message from the external device such as the mobile phone 120 or the server 130 for transmission of the image which is received at the image receiving unit 210 and encoded at the codec 250.

Particularly, the transmitting and receiving unit 270 may determine a destination where the image data is backed up, and transmit the image data to the external device such as the mobile phone 120 or the server 130 along with the information regarding the determined backup destination. Accordingly, if receiving the image data along with the backup destination information of the image data, the mobile phone 120 or the server 130 determines if it is selected as the destination of backup, and if so, backs up the received image data. If determining that the mobile phone 120 or the server 130 is not the destination of backup, the mobile phone 120 or the server 130 transmits the received image data to the selected destination of backup.

The operating unit 280 receives an input of user's command regarding operation of the digital camera 110, and transmits the inputted user's command to the control unit 240.

The control unit 240 controls the overall operation of the digital camera 110 based on a request for image transmission inputted through the transmitting and receiving unit 270 and the user's command inputted through the operating unit 280.

As mentioned above, the encoded image signal may be transmitted to the control unit 240 or the memory 260 depending on the mode of the digital camera 110. Hereinbelow, with reference to FIGS. 3A to 3D, a situation where the mode is shifted according to an embodiment will be explained.

FIGS. 3A to 3D illustrate a situation where the mode is set according to an embodiment.

First, the mode may be manually set by the user, in which case the user may directly manipulate the digital camera 110 and input a command through the operating unit 280.

Referring to FIG. 3A, if the user calls for a mode set screen through the operating unit 280, the mode set screen displays: i) image transmission mode; and ii) image storage mode. Accordingly, the user may set the mode of the digital camera 110 by selecting one of the displayed modes.

The ‘specific circumstances’ where the mode is automatically set without requiring a user's operation, may include the following.

First, if the memory capacity is full or insufficient, it is impossible or difficult to store the image data.

FIG. 3B illustrates the above circumstance. Referring to FIG. 3B, if the memory lacks during image photographing operation, the digital camera 110 may display an alarm message such as “Sorry, memory is full.” to indicate the current status of the memory 260, along with a guide message such as “transmitting to server . . . ” to indicate that the following images are now transmitted to the server. Unless a specific operation by the user is inputted, the digital camera 110 thus transmits the following images to the server 130.

Second, there may be a medium device to transmit the image generated at the digital camera 110 to the server 130. The medium device may be particularly necessary when the digital camera 110 and the server 130 operate in different communication manners. That is, a medium device, capable of communicating with the digital camera 110 and also the server 130, may be presented to enable communication between the digital camera 110 and the server 130.

FIG. 3C illustrates the above case in detail. Referring FIG. 3C, if the digital camera 110 photographing an image finds the mobile phone 120 as being located near the digital camera 110, the digital camera 110 may display a guide message such as “One mobile phone is found.” to indicate that the digital camera 110 found the mobile phone 120, along with another guide message such as “Transmitting to the server via mobile phone.” to indicate that the following images are transmitted to the server 130 via mobile phone 120. Unless a specific manipulation is inputted by the user, the digital camera 110 transmits to the mobile phone 120 the following image data along with a message requesting the mobile phone 120 to transmit the image data to the server 130.

Meanwhile, an authentication process to enable access among the digital camera 110, the mobile phone 120 and the server 130 may have been performed in advance for the transmission of the images from the digital camera 110 to the server 130 through the medium device such as the mobile phone 120, and the mobile phone 120 has to use the communication methods employed in the digital camera 110 and the server 130 to be able to communication with both the digital camera 110 and the server 130.

Third, a separate control device may be implemented to control the digital camera 110, or a command requesting the digital camera 110 to transmit the photographed image may be inputted from the server 130. Herein, the control device may be the mobile phone 120.

FIG. 3D illustrates the above situation in detail. Referring to FIG. 3D, if the digital camera 110 receives a request command for transmission of the photographed image during photographing, the digital camera 110 may display a guide message such as “A request for image is received.” to indicate the reception of the request for image transmission, along with another guide message such as “Transmitting to the server.” to indicate that the following images are transmitted to the server 130. Accordingly, unless a specific manipulation is inputted by the user, the digital camera 110 transmits the image data photographed thereafter to the server 130.

In the above case, if the digital camera 110 and the server 130 implement the same communication method, the images of the digital camera 110 may be transmitted to the server 130 directly. Alternatively, if the digital camera 110 and the server 130 implement different communication methods and the mobile phone 120 implements the communication methods of both, the images of the digital camera 110 may be transmitted to the server 130 via the mobile phone 120.

Although guide messages are displayed in the examples explained above, this is written only for convenience of explanation. Accordingly, other examples are possible. For example, the images may be transmitted to the server and there may not be a guide message.

Furthermore, the example where the user manually chooses between the image transmission mode and the image storage mode, or the example where these modes are selected automatically without requiring the user's manipulation under specific circumstances, are written only for illustrative purposes. Accordingly, the mode may be set differently.

Meanwhile, it has been explained above that the images photographed at the digital camera 110 may be transmitted to the server 130 via mobile phone 120, in which case the mobile phone 120 uses the communication method to communicate with the digital camera 110 and the communication method to communicate with the server 130.

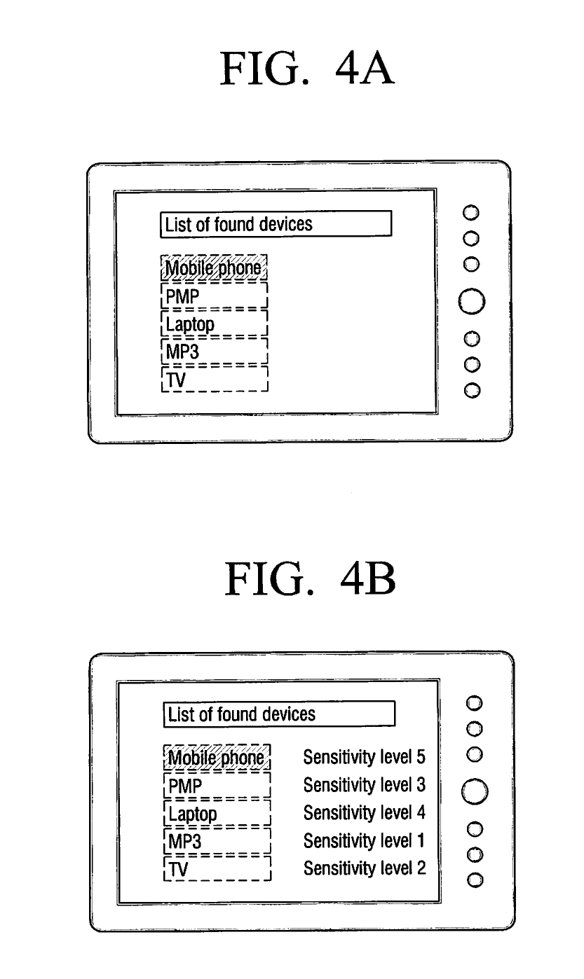

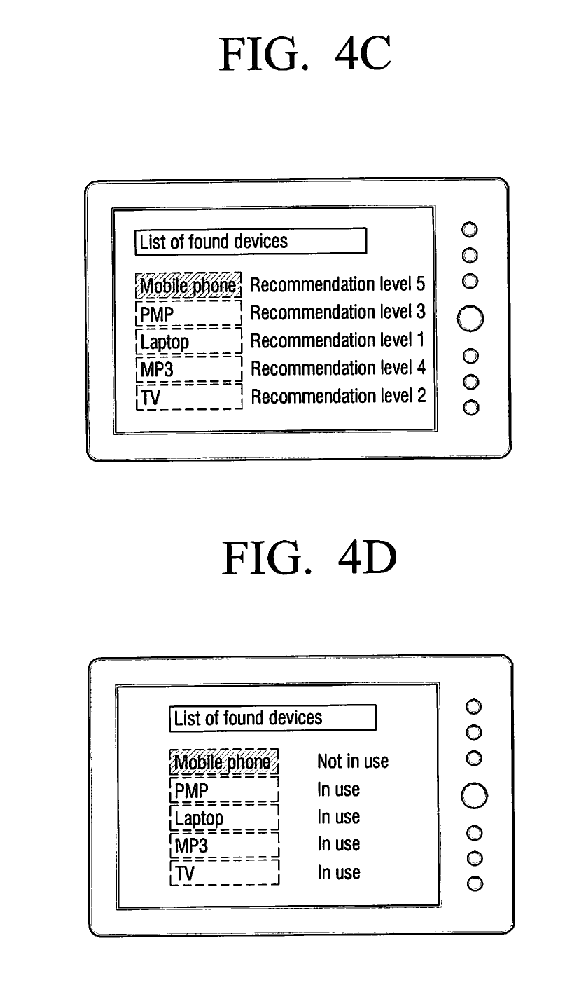

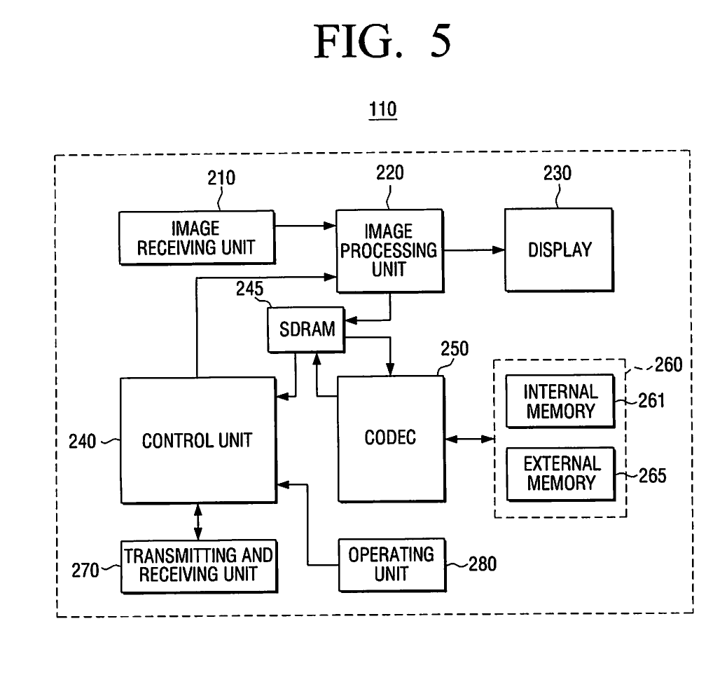

The situations where the data from the digital camera 110 can be transmitted to the server 130 via mobile phone 120, will be explained in greater detail below, with reference to FIGS. 4A to 4D.

FIGS. 4A to 4D are views provided to explain situations where the digital camera 110 may transmit data to the server 130 via mobile phone 120.

First, the digital camera 110 may select in advance the mobile phone 120 from among a plurality of surrounding devices, so that the image data acquired by the digital camera 110 is transmitted to the mobile phone 120 automatically to be transmitted to the server 130.

The above situation is illustrated in FIG. 4A in detail. Referring to FIG. 4A, the digital camera 110 may search communicable devices and display a list of the found devices. Accordingly, the user may select the mobile phone 120 from among the devices as found, so that the image data generated at the digital camera 110 is transmitted to the server 130 via mobile phone 120.

Herein, the list of found devices may include the surrounding devices of the digital camera 110, which employ the communicating manners of both the digital camera 110 and the server 130.

Next, the digital camera 110 may select in advance the device, for example, the mobile phone 120, from the list of found devices based on the highest communication sensitivity, so that the image data is transmitted to the selected mobile phone 120 to be transmitted to the server 130.

The above is illustrated in FIG. 4B. Referring to FIG. 4B, the digital camera 110 may search communicable devices and display a list of the found devices. In this case, the digital camera 110 may measure the level of communication sensitivities of the surrounding devices and display the measured information along with the names of the corresponding devices.

Accordingly, the user may cause a specific device (e.g., mobile phone 120) to be selected based on the highest communication sensitivity from among the surrounding devices as found, so that the image data generated at the digital camera 110 is transmitted to the mobile phone 120 to be transmitted to the server 130.

Herein, the ‘communication sensitivity’ may refer to the sensitivities for the surrounding devices to communicate with the digital camera 110, the sensitivities for the surrounding devices to communicate with the server 130, or the communication sensitivities for both of the above-mentioned types of communications. For example, if the communication sensitivity particularly relates to the communication between the surrounding devices and the server 130, the digital camera 110 may receive such information, i.e., the sensitivities of the surrounding devices to communicate with the server 130 from the surrounding devices respectively.

Next, the digital camera 110 may select in advance a specific device (e.g., mobile phone 120) from the list of found devices based on the highest level of recommendation which is generated at the digital camera 110, so that the photographed images are automatically transmitted to the selected mobile phone 120 to be transmitted to the server 130.

The above example is illustrated in FIG. 4C in detail. Referring to FIG. 4C, the digital camera 110 may search communicable devices and display a list of the found devices. In this case, the digital camera 110 may display the recommendation levels of the surrounding devices for communication along with the name of the corresponding devices.

Accordingly, the user may cause a specific device (e.g., mobile phone 120) to be selected from among the found devices based on the highest recommendation level for communication, so that the image data generated at the digital camera 110 is transmitted automatically to the mobile phone 120 to be transmitted to the server 130.

The ‘recommendation level for communication’ of the devices may be determined in consideration of the communication history records, communication error rates, or the like of the communication performed between the digital camera 110 and the surrounding devices. For example, the image captured at the digital camera 110 may be transmitted in error, or have an error generated therein, if the device, which is selected based on the currently highest level of sensitivity to receive the image from the digital camera 110, has previously suffered frequent communication cutoff.

Accordingly, in consideration of the history of erroneous transmission or details of the errors, the digital camera 110 may determine the recommendation levels for communication of the found devices in the list, and the user may cause a specific device (e.g., mobile phone 120) to be automatically selected based on the highest recommendation level so that the image data generated at the digital camera 110 is transmitted to the mobile phone 120 to be transmitted to the server 130.

Next, the digital camera 110 may set in advance that a specific device (e.g., mobile phone 120) to be selected from the list of found devices based on the current availability (i.e., if the device is currently not in use), so that the photographed image is transmitted to the selected mobile phone 120 to be transmitted to the server 130.

The above example is illustrated in FIG. 4D. Referring to FIG. 4D, if the digital camera 110 searches communicable surrounding devices and displays a list of the found devices on a screen, the digital camera 110 may also display information about the current availability of the surrounding devices along with the names of the corresponding devices.

Accordingly, the user may cause a specific device (e.g., mobile phone 120), which is currently not in use, to be selected, so that the image data generated at the digital camera 110 is transmitted to the mobile phone 120 to be transmitted to the server 130.

The detailed situations where the data from the digital camera 110 is transmitted to the server 130 via mobile phone 120 have been explained above. However, the above-explained examples are written only for illustrative purposes. Accordingly, the data from the digital camera 110 may be transmitted to the server 130 via mobile phone 120 in other situations, although not explained in detail herein.

Furthermore, although the digital camera 110 displays the list of found devices on the screen thereof, except for the situation where the user manually selects the mobile phone 120, the list of found devices may not be displayed at all and the mobile phone 120 may be selected automatically.

In one embodiment, it may be unnecessary to display the list of found devices unless there is a specific command inputted by the user to display the device list. In this case, the list of devices may be disappeared, or simply the information indicating the connected status to the mobile phone 120 may be displayed, once the communication is connected to the mobile phone 120.

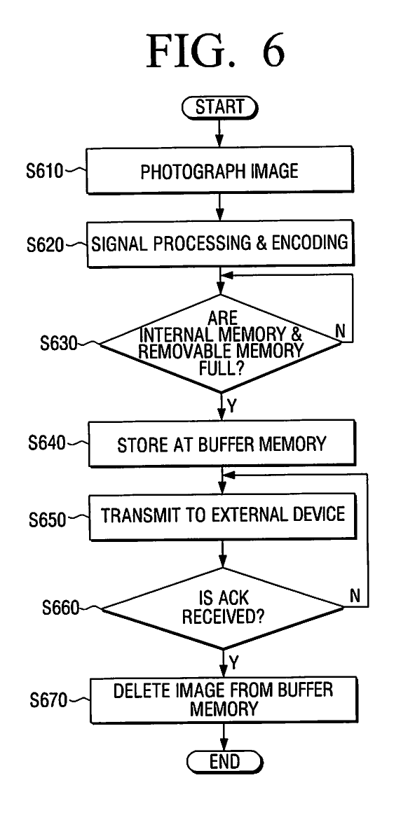

Meanwhile, among the exemplary situations explained above where the mode is set automatically without requiring the user manipulation, there is the situation where the memory capacity is full or insufficient so that it is impossible or difficult to store the image data in the memory 260. Regarding this, transmitting the photographed image to the server 130 via mobile phone 120 on real-time basis, without using either internal memory 261 or external memory 265, will be explained in detail below with reference to FIGS. 5 and 6.

FIG. 5 is a block diagram of the digital camera 110 to transmit the photographed images to the server 130 on real-time basis via mobile phone 120, without using either internal memory 261 or external memory 265.

Referring to FIG. 5, the digital camera 110 may include an image receiving unit 210, an image processing unit 220, a display 230, a control unit 240, a SDRAM 245, a codec 250, a memory 260, a transmitting and receiving unit 270, and an operating unit 280. Since the image receiving unit 210, the image processing unit 220, the display 230, the control unit 240, the SDRAM 245, the codec 250, the memory 260, the transmitting and receiving unit 270, and the operating unit 280 of FIG. 5 are almost identical to those 210, 220, 230, 240, 250, 260, 270, 280 of FIG. 2, explanation about overlapping components will be omitted for the sake of brevity. Accordingly, the SDRAM 245 will be explained in detail below.

The SDRAM 245 operates as a buffer, temporarily storing inputted images and processed images. That is, the SDRAM 245 provides a storage space which is necessary for the image processing unit to process image signal inputted through the image receiving unit 210, and compress the processed image.

The digital camera 110 may use the SDRAM 245 so as to transmit the photographed image to the server 130 on real-time basis via mobile phone 120, without using the internal memory 261 or the external memory 265.

FIG. 6 is a flowchart provided to explain a process of transmitting the photographed images on real-time basis.

At S610, if an image is photographed, at S620, the digital camera 110 performs signal processing and encoding with respect to the photographed image.

At S630, if the signal processing and the encoding are completed, the digital camera 110 determines if the internal memory 261 and the external memory 265 have sufficient storage space, and at S630-Y, if not, at S640, temporarily stores the encoded image in the SDRAM 245.

At S650, the digital camera 110 transmits the temporarily-stored image to an external device such as the mobile phone 120 or the server 130.

Meanwhile, the SDRAM 245 maintains the current storage status, instead of deleting the temporarily-stored image. At S660, if an ACK signal is received from the external device indicating that the image is received properly at the external device, at S670, the digital camera 110 confirms the received ACK and then deletes the stored image from the SDRAM 245.

Accordingly, the photographed images can be transmitted to outside and backed-up on real-time basis, and it is unnecessary to use the internal memory 261 or the external memory 265 in the process.

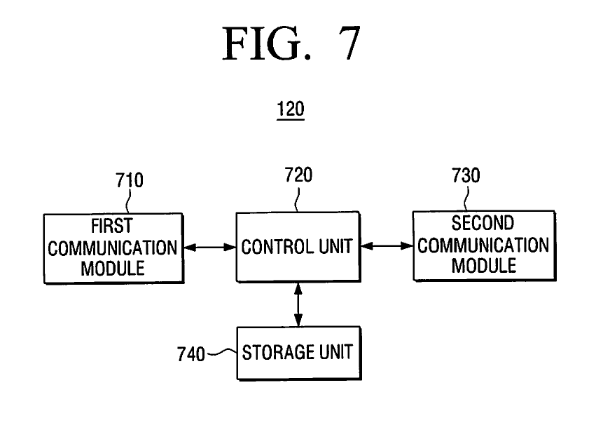

Hereinbelow, the role of the mobile phone 120 to transmit the photographed images from the digital camera 110 to the server 130 on real-time basis, will be explained in detail with reference to FIG. 7.

FIG. 7 is a block diagram of the mobile phone 120, in which only the components related to the embodiment are illustrated for convenience of explanation.

The mobile phone 120 may include a first communication module 710, a control unit 720, a second communication module 730, and a storage unit 740.

The first communication module 710 may communicate with an external device including the digital camera 110 in a communication manner different from that of the second communication module 730. The first communication module 710 may implement one of the short range communication methods such as Wi-Fi, Bluetooth, or the like.

Generally, the user carries around the mobile phone 120 or the digital camera 110. Accordingly, the first communication module 710 is used to communicate with the digital camera 110 in the short-range communication manner.

Accordingly, the first communication module 710 communicates with the digital camera 110 in the short-range communication manner, receives from the digital camera 110 the photographed images, and transmits an ACK signal to the digital camera 110 to indicate the safe reception of the photographed image.

Likewise, the second communication module 730 communicates with the external device including the server 130 in a communication manner different from that of the first communication module 710. The second communication module 730 may implement one of the telecommunication methods such as wireless Internet.

Typically, the user carries around the mobile phone 120, and the server 130 is fixed in place at home or office. Accordingly, the second communication module 730 is used to communicate with the server 130 in a telecommunication manner.

Accordingly, the second communication module 730 communicates with the server 130 in the telecommunication manner, and transmits an image photographed and received from the digital camera 110 to the server 130.

The storage unit 740 stores the image received from the digital camera 110, and also stores the information regarding the communication status with the server. The storage unit 740 may be implemented as a HDD, or a flash memory.

The control unit 720 controls the overall operation of the mobile phone 120.

As explained above, since the mobile phone 120 is capable of trans-networking using the first and second communication modules 710, 730, data transmission between the two devices, which would be impossible otherwise, is performed.

In the example explained above, the digital camera 110 is implemented as the data generating device, the mobile phone 120 is implemented as the data transmitting device, and the server 130 is implemented as the remote backup device. However, such examples were written only for illustrative purposes, and other examples are also possible. That is, other types of devices may be implemented as the data generating device, data transmitting device or the remote backup device.

For example, a MP3 player with a microphone attached thereto, which is implemented as the data generating device, may transmit recorded voice data to a TV, implemented as the remote backup device, via PMP which is implemented as the data transmitting device. In the above example, the data generating device (i.e., MP3 player) may employ a communication manner suitable for communication with the data transmitting device (i.e., PMP), and also a communication method suitable for communication with the remote backup device (i.e., TV).

Also in the examples explained above, the data generated at the data generating device is transmitted to the remote backup device via data transmitting device, these are only applicable when the data generating device and the remote backup device need to use the data transmitting device therebetween because the two employ different communication methods from each other. Accordingly, if the data generating device and the remote backup device have the same communication method, data transmission and reception is possible without using the data transmitting device.

In one embodiment, even the data generating device and the remote backup device having the identical communication method may still use the data transmitting device to transmit data in the event, for example, where there is poor communication.

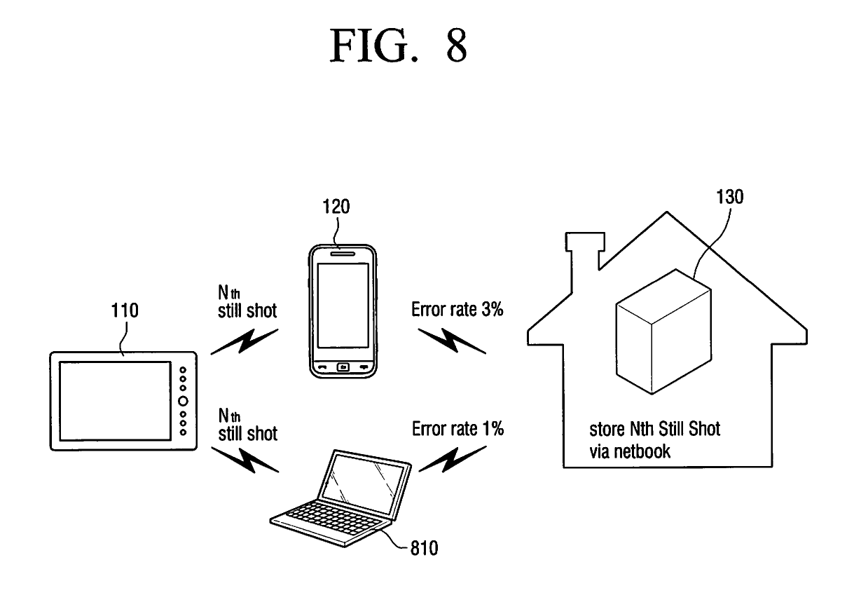

Furthermore, in the examples explained above, one is selected from among two or more data transmitting devices. However, this is written only for illustrative purpose. In another example, the data generating device may back up the data to the remote backup device via two or more data transmitting devices. This example is illustrated in FIG. 8.

FIG. 8 is a view provided to explain a method of transmitting data via a plurality of data transmitting devices.

Referring to FIG. 8, if the digital camera 110 photographs an object and generates a corresponding photographed image, the digital camera 110 transmits the photographed image (‘(N)th photographed image’) to the mobile phone 120 and the netbook 810 concurrently.

The mobile phone 120 and the netbook 810 transmit the (N)th photographed image from the digital camera 110 to the server 130. The server 130 receives both the error rate of the data transmitted via the mobile phone 120 and the error rate of the data transmitted via the netbook 810.

In the above particular example, data may be overlappingly backed up at the server 130, thereby occupying unnecessarily large storage space of the server 130. To prevent this, the server 130 may compare the error rate of the (N)th photographed image transmitted via the mobile phone 120 with the error rate of the (N)th photographed image transmitted via the netbook 810, and select the (N)th photographed image transmitted via the route (e.g., netbook 810) which has the lower error rate. As a result, unnecessary use of the storage space can be avoided.

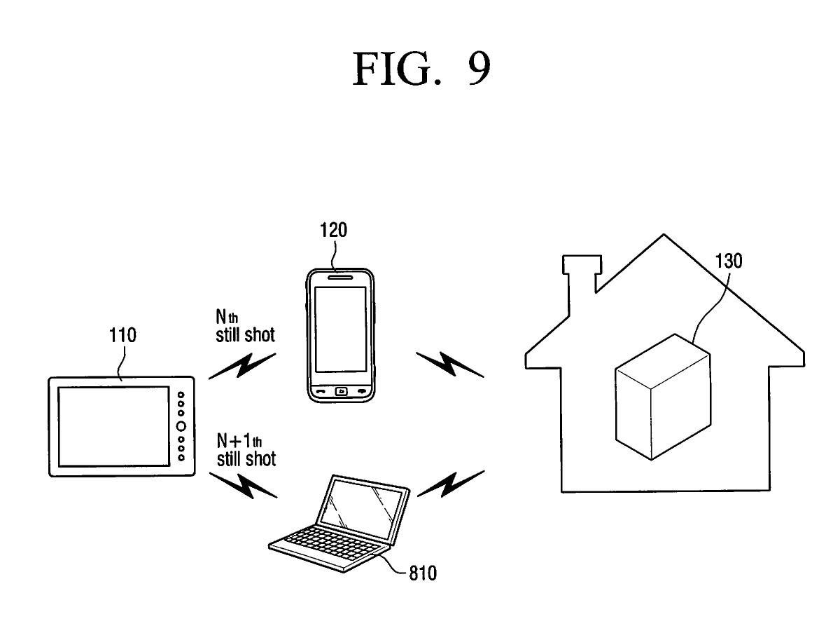

In another embodiment, if all the plurality of data transmitting devices have good communication status, image backup at the remote backup device may be performed using the plurality of data transmitting devices in the order of generating the images. This example is illustrated in FIG. 9.

FIG. 9 is a view provided to explain a method of transmitting data via a plurality of data transmitting devices.

Referring to FIG. 9, the digital camera 110 photographs an object and generates a photographed image, and transmits the (N)th photographed image to the mobile phone 120. The mobile phone 120 transmits the (N)th photographed image received from the digital camera 110, to the server 130 on real-time basis.

Next, the digital camera 110 photographs the next image, i.e., (N+1)th photographed image, and transmits the (N+1)th photographed image to the netbook 810. the netbook 810 transmits the (N+1)th photographed image received from the digital camera 110 to the server 130 on real-time basis.

As explained above, data processing at the data transmitting device may be expedited, as the images generated at the data generating device is distributed and transmitted through a plurality of data transmitting devices.

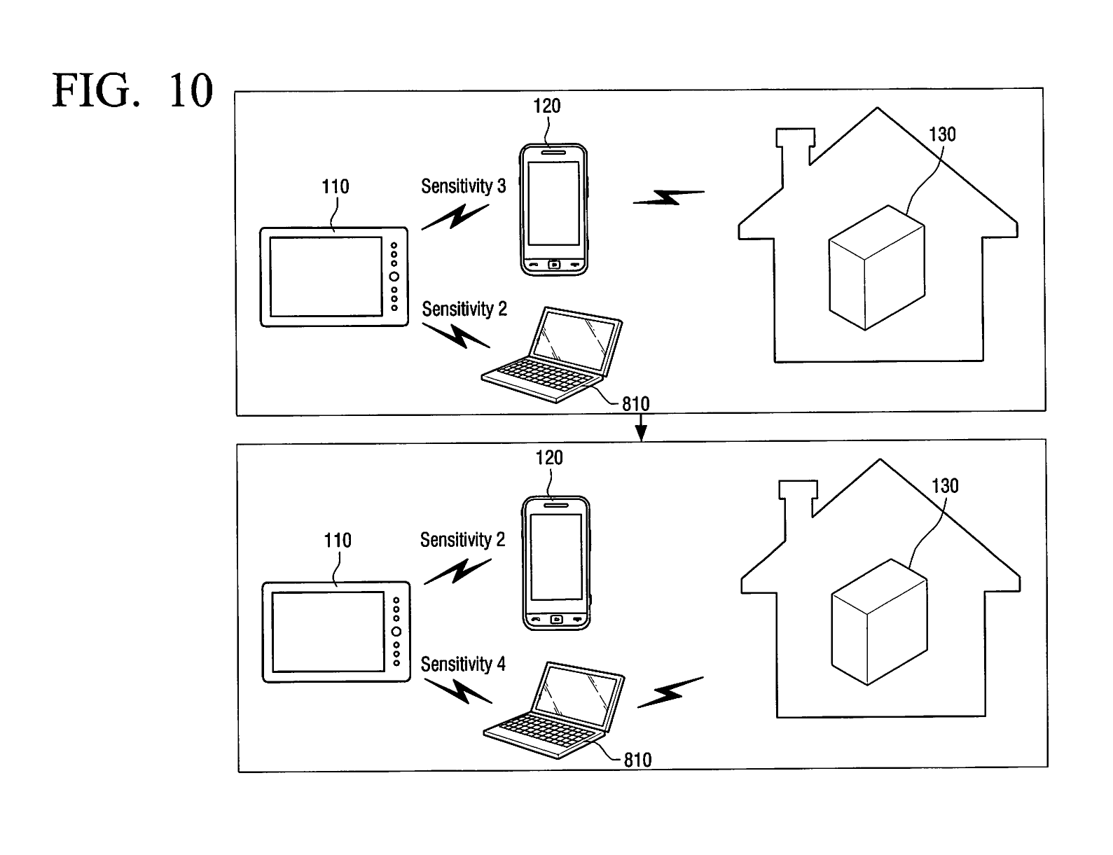

In the example where one is selected from among two or more data transmitting devices to transmit the data, the data generating device may change the data transmitting device to another to back up the images at the remote backup device. This example is illustrated in FIG. 10.

FIG. 10 is a view provided to explain a method of transmitting data through a plurality of data transmitting devices.

Referring to the illustration on the upper-half of FIG. 10, the digital camera 110 photographs an object and generates a photographed image, and transmits the photographed image to the mobile phone 120. The mobile phone 120 transmits the photographed image received from the digital camera 110 to the server on real-time basis. In this situation, the digital camera 110 checks regularly the communication status with the mobile phone 120 and with the other data transmitting devices.

If determining the communication status with the mobile phone 120 to be good, as illustrated in the upper-half of FIG. 10, the digital camera 110 keeps backing up the photographed images via mobile phone 120.

However, if determining the communication status with the mobile phone 120 to be poor, or if determining a presence of the data transmitting device (e.g., netbook 810) with the better communication status, as illustrated in lower-half of FIG. 10, the digital camera 110 backs up the photographed image at the server 130 via the netbook 810, while discontinuing the backup through the mobile phone 120.

In other words, the data generating device may change the currently-selected data transmitting device to a new one with better communication status, if determining the communication status with the currently-selected data transmitting device to be gradually deteriorating or if the communication status with unselected data transmitting device is gradually improving.

Although the images generated at the data generating device are explained as being backed up at the remote backup device as the images are generated, other example is possible. That is, the data generating device or the data transmitting device may check the quality, error rate, etc., of the generated or received images and cause only the images with the predetermined level of quality or error rate to be backed up at the remote backup device.

For example, while transmitting the photographed image to the server 130 via mobile phone 120, the digital camera 110 may directly delete the images below a predetermined quality, instead of sending the image to the mobile phone 120. The mobile phone 120 may also delete the received image, instead of sending the image to the server 130, if determining that the received image has the error rate above predetermined degrees.

The foregoing exemplary embodiments and advantages are merely exemplary and are not to be construed as limiting the present invention. The present teaching can be readily applied to other types of apparatuses. Also, the description of the exemplary embodiments of the present inventive concept is intended to be illustrative, and not to limit the scope of the claims, and many alternatives, modifications, and variations will be apparent to those skilled in the art.

What is claimed is:

1. A remote data backup system, comprising:
a data generating device which generates image or voice data, and transmits the generated data to outside based on a communication status;
a data transmitting device which transmits the received data to outside, if receiving from the data generating device the generated data; and
a remote backup device which backs up the data received from the data generating device or the data transmitting device on real-time basis.

2. The remote data backup system of claim 1, wherein the data generating device transmits the generated data to the data transmitting device or the remote backup device based on whether or not: the data generating device has a sufficient memory capacity; the data transmitting device is found near the data generating device; a command to transmit the data is received from the data transmitting device or the remote backup device; or the data generating device is set to an image transmission mode based on a user's manipulation.

3. The remote data backup system of claim 1, wherein the data generating device transmits the generated data to the remote backup device, if communication with the remote backup device is possible, and transmits the generated data to the data transmitting device, if communication with the remote backup device is impossible.

4. The remote data backup system of claim 1, wherein the data generating device selects a device from a list of devices communicable with the data generating device, based on communicability with the remote backup device, to determine the selected device as the data transmitting device.

5. The remote data backup system of claim 4, wherein the device with the communicability with the remote backup device is selected directly by a user, or in consideration of at least one of: communicational sensitivity with the data generating device; communicational sensitivity with the remote backup device; communication history records with the data generating device; error rate during communication with the data generating device; and whether or not the device is used by the user.

6. A remote data backup method, comprising:
generating image or voice data, and transmitting the generated data to outside along with information about a backup destination of the generated data;
at a device receiving the data, determining the backup destination of the data; and
at the device receiving the data, transmitting the data to the determined backup destination.
